(19) United States
(12) Patent Application Publication
(10) Pub. No.: US 2024/0194074 A1
(43) Pub. Date: Jun. 13, 2024

(54) WARNING SYSTEMS AND METHODS

(71) Applicant: Peter Kakoyiannis, Yardley, PA (US)

(72) Inventor: Peter Kakoyiannis, Yardley, PA (US)

(21) Appl. No.: 18/534,040

(22) Filed: Dec. 8, 2023

Related U.S. Application Data
(60) Provisional application No. 63/386,976, filed on Dec. 12, 2022.
(60) Provisional application No. 63/534,480, filed on Aug. 24, 2023.

(51) Int. Cl. G08G 1/16; B60W 50/16; G01S 13/53; G01S 13/931; G06V 20/54; G06V 20/62; G08G 1/017

(52) U.S. Cl. CPC G08G 1/164; B60W 50/16; G01S 13/53; G01S 13/931; G06V 20/54; G06V 20/625; G08G 1/0175; G08G 1/166; B60W 2050/143

(57) ABSTRACT

Vehicle warning systems and methods comprising at least one detection device having instructions stored in a memory and executed by one or more processors communicatively coupled with a capture device and a sensor, wherein the one or more processors are configured to receive identification data and detection data of a vehicle travelling along a path from the at least one detection device, wherein the detection data includes distance, speed, and position data measured by the sensor; determine whether the vehicle is travelling along the path in an erroneous direction; and provide a warning across a network to a receiving device associated with the vehicle, wherein the warning alerts an operator of the vehicle of travel in the erroneous direction.

### REFERENCED APPLICATIONS

The present application claims priority on U.S. Provisional Patent Application Ser. No. 63/534,480 filed Aug. 24, 2023 and U.S. Provisional Patent Application Ser. No. 63/386,976 filed Dec. 12, 2022, the disclosures of which are both all incorporated herein by reference.

### TECHNICAL FIELD

The present disclosure relates generally to warning systems and methods and telecommunications networks relating thereto. Specifically, the warning systems and methods allow for improved use of transportation and transportation safety.

### BACKGROUND

Various types of transportation are integral to a functioning society. Nonetheless, each type of transportation bears its own limitations and safety risks. Cars and other motor vehicles, for example, allow their operators a certain degree of autonomy in their travel, but crashes can cause injury to the operators and/or others, damage to the motor vehicles or other property, and traffic delays. For example, a driver that is driving a vehicle in the wrong direction can cause severe injury to the driver, the driver's vehicle, other drivers and their vehicles. However, there is currently no system to forewarn potentially affected drivers that some driver is driving the wrong way and is headed in their direction.

There remains an ongoing need for improvements in safety for all types of transportation and, in particular, reducing the number of crashes involving one or more motor vehicles.

### SUMMARY

The present disclosure relates generally to warning systems and methods and telecommunications networks relating thereto to improve transportation safety. In accordance with one non-limiting embodiment of the disclosure, there is provided a vehicle warning system. In one non-limiting configuration, the vehicle warning system includes a) a detection system that is configured to receive identification data and detection data of a vehicle travelling along a path relative to the detection system, and b) a warning system that provides a warning across a network to a receiving device associated with the vehicle, and wherein the warning alerts an operator of the vehicle of travel of the vehicle in an erroneous direction. The detection system can included one or more detection arrangements located along a road or highway. The detection system can be configured to a) determine whether the vehicle is travelling along a path in an erroneous direction, b) the speed of the vehicle, c) the location of the vehicle in real-time or intermittent time periods (e.g., every 1 second to every hour and all values and ranges therebetween), d) distance of the vehicle from one or more of the detection arrangements, e) distance of the vehicle from one or more other vehicles, f) time period of potential collision of the vehicle with one or more other vehicles, g) general size of the vehicle and/or the one or more other vehicles in the potential path of the vehicle, and/or the speed and/or location of the one or more other vehicles that are in the potential path of the vehicle. The detection system can include instructions stored in a memory and executed by one or more processors communicatively coupled with a capture device and sensor arrangement, and wherein the one or more processors are configured to receive identification data and detection data of the vehicle travelling along a path to and/or from the detection system, and wherein the detection data includes various types of data (e.g., distance data, speed data, position data, vehicle size data, etc.) measured by the sensor arrangement. The detection system can be configured to determine whether the vehicle is travelling along a path in an erroneous direction; and the warning system can be configured to a) provide a warning across a network (e.g., mobile network, internet, satellite system, cloud system, etc.) to i) a receiving device associated with the vehicle, ii) to a receiving device associated with one or more other vehicles, iii) one or more government agencies (e.g., police, fire department, highway maintenance agency, emergency management agency, traffic agency, public safety agency, utilities, parole and probation officers, etc.), iv) one or more emergency services (e.g., hospital, tow trucks, utilities, etc.), v) highway or road constructions companies, vi) toll road operators, and/or vii) one or more public service companies (e.g., community service agencies, churches, charity organizations, etc.); and/or b) provide warning alerts to the operator of the vehicle that is travelling in the erroneous direction. In another non-limiting embodiment, the detection system and/or warning system can be optionally configured, through the network and/or other means, to a) identify one or more groups of potentially affected vehicles that could potentially encounter the vehicle that is travelling in the wrong direction, and/or b) identify homes or other residence structures (etc. motel, hotel, apartment, condo, etc.), businesses (e.g., business buildings, gas stations, restaurants, etc.), hospitals, government buildings, airports, public transportation stations, areas of public gatherings (e.g., parks, bus stops, etc.), etc., that could potentially encounter the vehicle that is travelling in the wrong direction; and b) provide a secondary warning to a receiving device associated with a) such one or more other potentially affected vehicles and/or b) such homes or other residence structures, business, hospitals, government buildings, airports, public transportation stations, areas of public gatherings, etc., and wherein the secondary warning alerts i) an operator or individual in such one or more other potentially affected vehicles and/or b) an individual at such homes or other residence structures, business, hospitals, government buildings, airports, public transportation stations, areas of public gatherings, etc., of the vehicle that is travelling in the wrong direction. The one or more groups of potentially affected vehicles can include, but are not limited to, a) affected vehicles approaching the vehicle, b) affected vehicles being approached by the vehicle, c) traffic that could encounter the vehicle, d) emergency authorities, e) traffic authorities, and/or f) law authorities.

In accordance with another non-limiting aspect of the present disclosure, the vehicle warning system can optionally be configured to remotely issue a moving violation to the vehicle if the vehicle is determined to be travelling along a path in the erroneous direction. The issued moving violation can be emailed, texted, and/or mailed to the owner of the vehicle and/or driver of the vehicle. Alternatively, the vehicle warning system can provide information to an agency (e.g., department of public safety, toll agency, etc.) which can use the provided information to issue a moving violation to the owner of the vehicle and/or driver of the vehicle.

In accordance with another non-limiting aspect of the present disclosure, the capture device of the vehicle warning system can include one or more optical sensors (e.g., cameras, satellite imaging, and/or other type of imaging device). The capture device is configured to obtain/capture identification data of the vehicle (e.g., vehicle make, vehicle model, license plate number, vehicle shape, vehicle size, vehicle color, distinguishing features on the vehicle, number of passengers in the vehicle, sex of one or more passengers in the vehicle, distinguishing features of one or more passengers in the vehicle, etc.). In one non-limiting embodiment, the vehicle warning system can include one or more optical sensors (e.g., optical camera, etc.) and one or more sensors (e.g., RF sensors, radar, etc.) and a radio frequency communications system that is configured to alert the relevant transportation and security authorities of the pending dangers with the vehicle travelling along a path in the erroneous direction. In one non-limiting embodiment, video cameras (e.g., day and night cameras, etc.) and/or other types of cameras can be employed at highway entrances, tram lines, etc., as well as one-way city streets in order to observe the relevant traffic, and in the event that a vehicle is moving in an erroneous direction, a telecommunication signal can be transmitted (e.g., RF transmission [radio frequency transmission], transmission via a network and/or cloud, etc.) to a public safety agency, transportation and policing authorities, etc., of the vehicle travelling in the wrong direction. A GPS system can optionally be used to provide supplemental information to locate the vehicle travelling along a path in the erroneous direction; however, GPS information is not generally very accurate. In accordance with another non-limiting aspect of the present disclosure, the vehicle warning system including the use of one or more sensors can include radar (e.g., Coherent pulsed (CP), Pulse-Doppler radar, Continuous wave (CW), Frequency modulation (FM), Mono-Pulse Doppler Radar, etc.). The radar can be used to obtain information about the vehicle in one or more pulses. The radar can be used to measure i) the distance of the offending vehicle from the sensor, ii) the speed of the offending vehicle, and/or iii) the position of the offending vehicle. Multibeam antennas can optionally be used to cover the total width of a highway for a reasonable distance. The maximum distance of antenna coverage can be set either by the factory or by the appropriate authority. The beamwidth of the main radar beam can be configured to cover the total width of the road at the maximum range of the radar while any additional main beams of the radar can optionally be configured to cover the road at shorter distances and fade as the distance increases. This can be achieved by reducing the power of the side main beams or by using a range gate system. Many modern vehicles are fitted with computers today that may be programmed to respond to instructions from the vehicle warning system (e.g., stop engine, slow vehicle, cause vehicle to move off road, provide a notice to the operator via the radio and/or display screen in the vehicle, etc.) and also provide information about the registration plate number, and VIN of the offending vehicle. Older or historic cars that do not have a computer can be contacted via the vehicle radio. The vehicle warning system can also or alternatively contact the driver of the vehicle by displaying messages, images, etc., on transportation boards that are located along a road or highway. As such, the receiving device associated with the vehicle may comprise a display wherein the warning is visually presented to the operator through the display (e.g., flashing light, messages, warning signs, etc.; and/or a speaker wherein the warning is audibly presented to the operator through the speaker. The warning may also or alternatively be presented to the operator through the receiving device in the form of a vibration wherein the vibration is emitted through a steering wheel and/or seat. In another non-limiting embodiment, the vehicle warning system is a) able to identify a vehicle travelling in the incorrect direction, b) obtain information about the vehicle such that some type of communication (e.g., RF communication, laser light communication, etc.) can be established with the vehicle (e.g., satellite communication, cell tower communication, radio to radio communication, etc.), c) cause/enable/allow one or more signals (e.g., RF signal, laser signal, etc.) to be transmitted to the vehicle so that a warning is provided to one or more individuals in the vehicle that the vehicle is travelling in the wrong direction, and/or d) optionally sending one or more signals (e.g., RF signals, laser signal, etc.) to the vehicle to cause the vehicle to i) slow down (e.g., brake, decelerate, etc.), ii) stop (e.g., stop movement stop engine, etc.), iii) move to the side of a road or highway, iv) turn around, v) drive to a particular location, vi) turn on the emergency lights, vii) activate the phone in the vehicle to begin a call with one or more of the individuals in the vehicle, viii) activate/control one or more lights in the interior and/or exterior of the vehicle (e.g., flash lights, brighten lights, dim lights, etc.), ix) activate radio, and/or x) activate the horn on the vehicle. The warning to the vehicle operator can also or alternatively be conveyed via a phone or smart device alert (e.g., mobile phone alert, smart device alert, iPad alert, tablet alert, computer alert, etc.). The emergency alert can be sent by a government agency to all phones in a particular region (e.g., 0.01-100 miles within location of the vehicle moving in the wrong direction and all values and ranges therebetween) that the vehicle moving in the wrong direction is located. The phone alert can be used to not only warn the driver of the vehicle, but also warn other individuals, businesses, other vehicle drivers, etc. of the vehicle that is traveling in the wrong direction. As can be appreciated, the alert can also or alternatively be transmitted to roadside electronic signs to provide notice to both the driver of the vehicle going in the wrong direction and other vehicles and individuals that are viewing the roadside electronic signs of the vehicle moving in the wrong direction. The alert to the roadside electronic signs can be sent by a government agency to all roadside electronic signs in a particular region (e.g., 0.01-100 miles within location of the vehicle moving in the wrong direction and all values and ranges therebetween) that the vehicle moving in the wrong direction is located. The present disclosure contemplates that the vehicle travelling along the path can include automobiles, trains, trams, motorcycles, scooters, and/or bicycles, and any other vehicle that is operated by a user. As can be appreciated, the alert can also or alternatively be transmitted to traffic signals to cause the traffic signals to change to red, flash red, or change to flash to other colors to cause all traffic to slow or stop in a region about the region that the vehicle going in the wrong direction. As can be appreciated, the alert can also or alternatively be transmitted to traffic cameras and/or other cameras in the region about the region that the vehicle going in the wrong direction so as to record and/or provide additional information about the vehicle going in the wrong direction, as well as other vehicles, individuals, buildings, structures, etc. in the region about the region that the vehicle going in the wrong direction. In accordance with another non-limiting aspect of the present disclosure, there is provided a method for using a vehicle warning system that includes a) positioning at least one detection device that includes one or more capture devices and one or more sensors along a path of travel; b) receiving, by one or more processors communicatively coupled with the one or more capture devices and the one or more sensors, identification data and detection data of a vehicle travelling along the path of travel, and wherein the detection data includes one or more of distance, speed, position data, and/or vehicle identification data measured/determined by the one or more sensor; c) determining, by the one or more processors, whether the vehicle is travelling along the path in an erroneous direction; and d) providing, by the one or more processors, a warning across a network to a receiving device associated with the vehicle, wherein the warning alerts an operator of the vehicle of travel in the erroneous direction. The method may optionally further comprise, by the one or more processors, identifying one or more groups of potentially affected vehicles based on proximity to the vehicle; and providing a second warning to a second receiving device associated with the one or more groups of potentially affected vehicles, wherein the second warning alerts a second operator of the one or more groups of potentially affected vehicles of the vehicle travelling in the erroneous direction. The one or more groups of potentially affected vehicles may include vehicles approaching the vehicle, vehicles being approached by the vehicle, traffic, emergency, and law authorities, or combinations thereof. The method may optionally further comprise, by the one or more processors, remotely issuing a moving violation to the vehicle if the vehicle is travelling along the path in the erroneous direction. The capture device may comprise a camera operable to capture the identification data of the vehicle, wherein the identification data includes vehicle make, vehicle model, license plate numbers, etc. The sensor include Doppler radar (e.g., Mono-Pulse Doppler Radar, etc.) that measures the detection data in one or more pulses. The receiving device associated with the vehicle may comprise a display, wherein the warning is visually presented to the operator through the display; and/or a speaker, wherein the warning is audibly presented to the operator through the speaker. The warning may optionally be presented to the operator through the receiving device in the form of a vibration, wherein the vibration is emitted through a steering wheel, seat, etc. The vehicle travelling along the path may include automobiles, trains, trams, motorcycles, scooter, bicycle, etc.

In accordance with another non-limiting aspect of the present disclosure, there is provide a vehicle warning system for detecting a vehicle travelling in an erroneous direction along a path of travel, wherein the vehicle warning system includes at least one detection device having instructions stored in a memory and executed by one or more processors communicatively coupled with a capture device and a radar system (e.g., Mono-Pulse Doppler Radar, etc.), and wherein the one or more processors are configured to receive identification data and detection data of the vehicle from the at least one detection device, wherein the detection data includes distance, speed, position data, and/or vehicle information that is measured/identified/determined by the radar system; and to thereby determine whether the vehicle is travelling along the path in an erroneous direction; and to provide a warning across a network to a receiving device associated with the vehicle, wherein the warning alerts an operator of the vehicle of travel in the erroneous direction; and through the network, identify one or more potentially affected vehicles along the path of travel based on proximity to the vehicle; and through the network, provide a second warning to a second receiving device associated with the one or more potentially affected vehicles, wherein the second warning alerts a second operator of the one or more potentially affected vehicles of the vehicle travelling in the erroneous direction; and through the network, provide a third warning to a third receiving device associated with one or more traffic, emergency, and/or law authorities, wherein the third warning alerts the authorities of the vehicle travelling in the erroneous direction. The one or more processors may further be configured to remotely issue a moving violation to the vehicle if the vehicle is travelling along the path in the erroneous direction.

One non-limiting object of the present disclosure is the provision of a vehicle warning system that can detect a vehicle travelling in an incorrect direction and then send a warning to the operator of the vehicle that the vehicle is travelling in the incorrect direction.

Another non-limiting object of the present disclosure is the provision of a vehicle warning system that optionally can a) identify a vehicle travelling in the incorrect direction, b) obtain information about the vehicle such that some type of communication (e.g., RF communication, laser light communication, etc.) can be established with the vehicle (e.g., satellite communication, cell tower communication, radio to radio communication, etc.), c) cause/enable/allow one or more signals (e.g., RF signal, laser signal, etc.) to be transmitted to the vehicle so that a warning is provided to one or more individuals in the vehicle that the vehicle is travelling in the wrong direction, and/or d) optionally sending one or more signals (e.g., RF signals, laser signal, etc.) to the vehicle to cause the vehicle to i) slow down, ii) stop, iii) move to the side of a road or highway, iv) turn around, v) drive to a particular location, vi) turn on the emergency lights, vii) activate the phone in the vehicle to begin a call with one or more of the individuals in the vehicle, viii) activate/control one or more lights in the interior and/or exterior of the vehicle, ix) activate radio, and/or x) activate the horn on the vehicle.

Another non-limiting object of the present disclosure is the provision of a vehicle warning system that includes a) a detection system that is configured to receive identification data and detection data of a vehicle travelling along a path relative to the detection system, and b) a warning system that provides a warning across a network to a receiving device associated with the vehicle, and wherein the warning alerts an operator of the vehicle of travelling in an erroneous direction.

Another non-limiting object of the present disclosure is the provision of a vehicle warning system wherein the detection system can included one or more detection arrangements located along a road or highway.

Another non-limiting object of the present disclosure is the provision of a vehicle warning system wherein the detection system is optionally configured to a) determine whether the vehicle is travelling along a path in an erroneous direction, b) the speed of the vehicle, c) the location of the vehicle in real-time or intermittent time periods, d) distance of the vehicle from one or more of the detection arrangements, e) distance of the vehicle from one or more other vehicles, f) time period of potential collision of the vehicle with one or more other vehicles, g) general size of the vehicle and/or the one or more other vehicles in the potential path of the vehicle, and/or h) the speed and/or location of the one or more other vehicles that are in the potential path of the vehicle.

Another non-limiting object of the present disclosure is the provision of a vehicle warning system that is optionally configured to a) provide a warning across a network (e.g., mobile network, internet, satellite system, cloud system, etc.) to i) a receiving device associated with the vehicle, ii) to a receiving device associated with one or more other vehicles, iii) one or more government agencies iv) one or more emergency services, v) highway or road constructions companies, vi) toll road operators, and/or vii) one or more public service companies; and/or b) provide warning alerts to the operator of the vehicle that is travelling in the erroneous direction.

Another non-limiting object of the present disclosure is the provision of a vehicle warning system wherein the detection system is optionally configured, through the network and/or other means, to a) identify one or more groups of potentially affected vehicles that could potentially encounter the vehicle that is travelling in the wrong direction, and/or b) identify homes or other residence structures, businesses, hospitals, government buildings, airports, public transportation stations, areas of public gatherings, etc., that could potentially encounter the vehicle that is travelling in the wrong direction; and b) provide a secondary warning to a receiving device associated with i) such one or more other potentially affected vehicles and/or ii) such homes or other residence structures, business, hospitals, government buildings, airports, public transportation stations, areas of public gatherings, etc., and wherein the secondary warning alerts I) an operator or individual in such one or more other potentially affected vehicles and/or II) an individual at such homes or other residence structures, business, hospitals, government buildings, airports, public transportation stations, areas of public gatherings, etc., of the vehicle that is travelling in the wrong direction, and wherein the one or more groups of potentially affected vehicles can include, but are not limited to, a) vehicles approaching the vehicle, b) vehicles being approached by the vehicle, c) traffic that could encounter the vehicle, d) emergency authorities, e) traffic authorities, and/or f) law authorities.

Another non-limiting object of the present disclosure is the provision of a vehicle warning system that can optionally a) be configured to remotely issue a moving violation to the vehicle if the vehicle is determined to be travelling along a path in the erroneous direction, and/or b) provide information to an agency which can use the provided information to issue a moving violation to the owner of the vehicle and/or driver of the vehicle.

Another non-limiting object of the present disclosure is the provision of a vehicle warning system that includes a) a capture device that uses one or more sensors to obtain/capture identification data of the vehicle, and wherein the one or more sensors include optical camera, satellite imagery, GPS, RF sensors, radar, etc.), and b) a radio frequency communications system that is configured to alert the relevant transportation and security authorities of the pending dangers with the vehicle travelling along a path in the erroneous direction.

Another non-limiting object of the present disclosure is the provision of a vehicle warning system that includes a) at least one detection device having instructions stored in a memory and executed by one or more processors communicatively coupled with a capture device and a sensor, wherein the one or more processors are configured to i) receive identification data and detection data of a vehicle travelling along a path from the at least one detection device, wherein the detection data includes distance, speed, and position data measured by the sensor; ii) determine whether the vehicle is travelling along the path in an erroneous direction; and iii) provide a warning across a network to a receiving device associated with the vehicle, wherein the warning alerts an operator of the vehicle of travel in the erroneous direction.

Another non-limiting object of the present disclosure is the provision of a vehicle warning system wherein the one or more processors are further configured to, through the network, a) identify one or more groups of potentially affected vehicles based on proximity to the vehicle; and b) provide a second warning to a second receiving device associated with the one or more groups of potentially affected vehicles, wherein the second warning alerts a second operator of the one or more groups of potentially affected vehicles of the vehicle travelling in the erroneous direction.

Another non-limiting object of the present disclosure is the provision of a vehicle warning system wherein the one or more groups of potentially affected vehicles includes vehicles approaching the vehicle, vehicles being approached by the vehicle, traffic, emergency, and law authorities, or combinations thereof.

Another non-limiting object of the present disclosure is the provision of a vehicle warning system wherein the one or more processors are further configured to remotely issue a moving violation to the vehicle if the vehicle is travelling along the path in the erroneous direction.

Another non-limiting object of the present disclosure is the provision of a vehicle warning system wherein the capture device comprises a camera operable to capture the identification data of the vehicle, wherein the identification data includes vehicle make, vehicle model, license plate numbers, or combinations thereof.

Another non-limiting object of the present disclosure is the provision of a vehicle warning system wherein the sensor is a Mono-Pulse Doppler Radar that measures the detection data in one pulse.

Another non-limiting object of the present disclosure is the provision of a vehicle warning system wherein the receiving device associated with the vehicle includes a) a display, wherein the warning is visually presented to the operator through the display; and/or b) a speaker, wherein the warning is audibly presented to the operator through the speaker.

Another non-limiting object of the present disclosure is the provision of a vehicle warning system wherein the warning is presented to the operator through the receiving device in the form of a vibration, wherein the vibration is emitted through a steering wheel, seat, or combinations thereof.

Another non-limiting object of the present disclosure is the provision of a vehicle warning system wherein the vehicle travelling along the path includes automobiles, trains, trams, motorcycles, scooters, or bicycles.

Another non-limiting object of the present disclosure is the provision of a vehicle warning method that includes a) positioning at least one detection device comprising a capture device and a sensor along a path of travel; b) receiving, by one or more processors communicatively coupled with the capture device and the sensor, identification data and detection data of a vehicle travelling along the path of travel, wherein the detection data includes distance, speed, and position data measured by the sensor; c) determining, by the one or more processors, whether the vehicle is travelling along the path in an erroneous direction; and d) providing, by the one or more processors, a warning across a network to a receiving device associated with the vehicle, wherein the warning alerts an operator of the vehicle of travel in the erroneous direction.

Another non-limiting object of the present disclosure is the provision of a vehicle warning method that further includes a) identifying one or more groups of potentially affected vehicles based on proximity to the vehicle; and b) providing a second warning to a second receiving device associated with the one or more groups of potentially affected vehicles, wherein the second warning alerts a second operator of the one or more groups of potentially affected vehicles of the vehicle travelling in the erroneous direction.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is a block diagram of an example implementation of the disclosed vehicle warning system showing the basic components of the system;

FIG. 2 is a schematic diagram of an exemplary detection device of the vehicle warning system; and

FIG. 3 is a flow chart of an example method for using an example implementation of the disclosed vehicle warning system.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the systems and methods described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the systems and methods described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semipermanent, and/or semitemporary.

One or more implementations of the subject application will now be described with reference to the attached figures, wherein like reference numerals are used to refer to like elements throughout.

As described in more detail below, the disclosed technology generally relates to systems and methods for warning vehicle operators. More specifically, the disclosed systems and methods can be used to identify and warn of erroneous and/or illegal operation of motor vehicles to reduce the risk of vehicle accidents. Certain implementations of the disclosed technology provide systems and methods that: (i) alert the relevant authorities of erroneous and/or illegal operation of a vehicle; (ii) warn nearby vehicles and travelers of the potential collision danger; (iii) alert the offending vehicle and/or traveler of the imminent collision danger; and (iv) issue a warning, ticket, or similar moving violation to the offending vehicle and/or traveler. It is to be appreciated that this disclosure is not limited to automobiles. Rather, depending on the use case, the disclosed vehicle warning system can be used to alert any type of vehicle travelling in an erroneous or illegal direction, such as trains, trams, motorcycles, bicycles, or other suitable form of transportation. Further, in some embodiments, a user of the system may be a pedestrian who receives warnings and alerts via a mobile device, such as a smart phone.

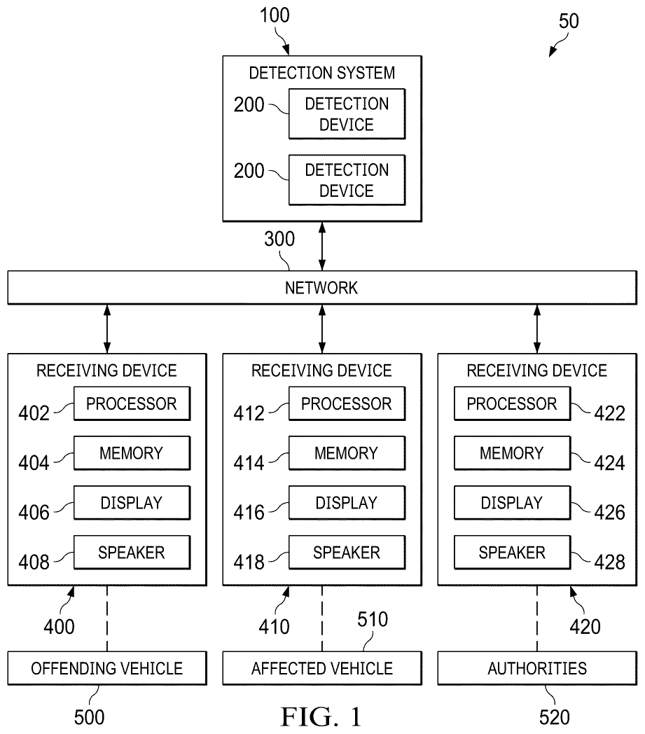

FIG. 1 shows a block diagram of an example implementation of a vehicle warning system 50 configured to identify and warn of the erroneous and/or illegal operation of motor vehicles. The vehicle warning system 50 comprises a detection system 100 having one or more detection devices 200; a telecommunications network 300; and one or more receiving devices 400, 410, 420 in communication with an offending vehicle 500, an affected vehicle 510, and/or relevant authorities 520, respectively.

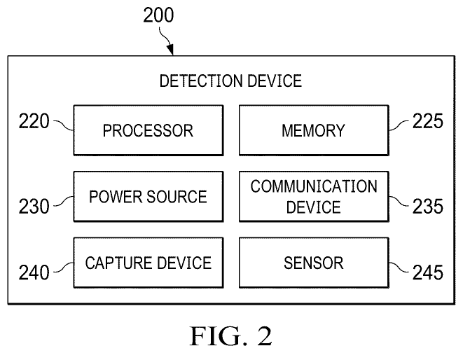

Detection system 100 comprising one or more detection devices 200, which is shown in detail in FIG. 2, identifies the erroneous and/or illegal operation of offending vehicle 500, such as operation of vehicle 500 in a direction opposite to the flow of traffic, operation of vehicle 500 in a restricted area, or any other situation in which operation of vehicle 500 imposes a consequential safety risk upon vehicle operators, other people, or property. As discussed further below, one or more detection devices 200 identifies offending vehicle 500, measures the distance, speed, and position data of offending vehicle 500, and determines whether offending vehicle 500 is under erroneous and/or illegal operation. In one exemplary embodiment, one or more detection devices 200 can be placed at the entrances of one-way streets or on the exit ramps of highways. In other certain embodiments, detection system 200 can be physically and/or electrically connected to offending vehicle 500. Suitable detection systems 100 may include any known systems relating to collision and lane control and other forms of radar. It will be appreciated, however, that any of a variety of known types of detection systems can be applied to the vehicle warning system 50.

Upon detection of erroneous and/or illegal operation of offending vehicle 500, detection system 100, through one or more detection devices 200, communicates with and sends information relating to offending vehicle 500 to telecommunications network 300. Network 300 receives, organizes, and disseminates the information relating to offending vehicle 500. In one embodiment, the information relating to offending vehicle 500 can include the location thereof (i.e. an affected area) and/or a physical description of the offending vehicle 500. In certain embodiments, the information can be transmitted to network 300 via radio frequency (RF) signals. It will be appreciated, however, that such information can be communicated via any of a variety of known transmission methods. In certain embodiments, network 300 can be a closed network, in which the network relates solely to the transmission of such information. In certain embodiments, network 300 can be used in association with other, existing networks to receive, organize, and communicate information.

Telecommunications network 300 can further assess any potential risks associated with offending vehicle 500 and can identify one or more groups of potentially affected vehicles 510 based on proximity to offending vehicle 500 and to the affected area. For example, the proximity could be based upon a position within a predetermined radius of the affected area or position on one or more specific highways or other streets in relation to the affected area. In certain embodiments, the one or more groups could also include potentially affected highway patrols, local emergency services, or other traffic or law enforcement agencies (collectively, authorities 520) where such authorities 520 can receive information relating to the erroneous and/or illegal operation through stationary or nomadic telecommunications systems, for example, at highway connections.

In certain embodiments, telecommunications network 300 can include a plurality of optical and/or RF systems. In such embodiments, the optical and/or RF systems can be placed at various positions to act as command centers. In certain embodiments, such optical and/or RF systems and any equipment and devices relating thereto, can be encrypted with advance encryption systems (AES) and can be uniquely identified by employing physical unclonable functions (PUF), similar to human fingerprints.

One or more receiving devices 400, 410, 420 receive notifications, warnings, and information across telecommunications network 300 about offending vehicle 500 and relay such warnings and information to the operators the offending vehicle 500 and affected vehicle 510, and/or relevant authorities 520, respectively. One or more receiving devices 400, 410, 420 can be any suitable vehicle computer systems; however, it will be appreciated that any of a variety of computer systems, such as a smart phone, can be configured to receive such warnings and information from telecommunications network 300.

In this embodiment, receiving device 400, associated with and in communication with offending vehicle 500, includes a processor 402, a memory 404, a display 406, and a speaker 408; the receiving device 410, associated with and in communication with affected vehicle 510, includes a processor 412, a memory 414, a display 416, and a speaker 418; and the receiving device 420, associated with and in communication with the relevant authorities 520, includes a processor 422, a memory 424, a display 426, and a speaker 428. In certain embodiments, receiving devices 400 and 410 can be physically and/or electrically, and removably or permanently, connected to vehicles 500 and 510, respectively. The warnings and information from network 300 can be transmitted via one or more signals, including RF signals. In one embodiment, the signals are transmitted at a frequency of 4.9 giga-Hertz (gHz). It will be appreciated, however, that such information can be communicated via any of a variety of known transmission methods. The warnings and information can be any notification relating to the erroneous and/or illegal operation of offending vehicle 500. For example, a warning can be a visual alert presented through display 406, 416, and/or 426, respectively; a sound alert emitted through speaker 408, 418, and/or 428, respectively; or a combination of the both. In certain embodiments, the warning can be in the form of a vibration, for example, in a vehicle steering wheel, a seat, or combinations thereof. In other embodiments, the warnings can result in a reduced speed for and/or disabling or other immobilization of a motor vehicle. It will be appreciated, however, that any of a variety of warning methods can be employed with the systems and networks described herein. For example, the one or more signals transmitted to the vehicle can be used to cause the vehicle to i) slow down, ii) stop, iii) move to the side of a road or highway, iv) turn around, v) drive to a particular location, vi) turn on the emergency lights, vii) activate the phone in the vehicle to begin a call with one or more of the individuals in the vehicle, viii) activate/control one or more lights in the interior and/or exterior of the vehicle, and/or ix) activate the horn on the vehicle.

In certain embodiments, one or more receiving devices 400, 410, 420 can be configured to receive only warnings relating to offending vehicle 500. In other embodiments, receiving devices 400, 410, 420 can be configured to receive such warnings relating to offending vehicle 500, as well as other types of relevant information. In certain embodiments, for example, receiving device 400, 410, 420 can be used in association with or incorporated into other, existing vehicle computer systems that can receive, organize, and communicate information. In certain embodiments, detection system 100, receiving devices 400, 410, 420, and any equipment relating thereto can be encrypted with AES and can be uniquely identified by employing PUF.

In some embodiments, different levels of warnings can be assessed by network 300 and transmitted to the or more receiving devices 400, 410, 420 depending on the group of affected vehicles and/or vehicle operators. For example, in network 300, the one or more groups of affected vehicles 510 and/or vehicle operators can be organized and identified by distance from the affected area. In certain embodiments, one group could include affected vehicles 510 and/or vehicle operators approaching offending vehicle 500 or the affected area, while another group could include affected vehicles 510 and/or vehicle operators being approached by offending vehicle 500.

Now referring to FIG. 2, one or more detection devices 200 comprises a processor 220 and a memory 225 that may be configured with instructions to control various other components, features, or aspects of the one or more detection devices 200. Memory 225 stores the executable software and data, and when processor 220 executes the software instructions, processor 220 can be caused to perform the various operations of one or more detection devices 200 and/or vehicle warning system 500. One or more detection devices 200 may further comprise a power source 230 and a communication device 235. Power source 230 may be an auxiliary or external power source that supplies power to all electrical components and modules of one or more detection devices 200. Communication device 235 may be one or more of a Bluetooth transceiver, Wi-Fi transceiver, cellular data transceiver, or other wireless communication device capable of exchanging information with remote or nearby devices.

With further reference to FIG. 2, one or more detection devices 200 may further comprise one or more visual capture devices 240 and one or more sensors 245 to observe relevant traffic and vehicles. For convention, only one visual capture device 240 and sensor 245 are depicted in FIG. 2. Visual capture device 240 may be any camera or video device capable of recognizing and capturing photographs and videos of the erroneous and/or illegal operation of motor vehicles at various resolutions and framerates. In some implementations, visual capture device 240 may capture identification data of offending vehicle 500, including, for example, vehicle make, vehicle model, and/or registration and license plate numbers. In some implementations, visual capture device 240 may be a day vision camera, a night vision camera, or a combination of the both.

Sensor 245 may be a radio frequency (RF) radar, or any radar, digitizer, or similar sensing devices that measures distance, speed, and position of any vehicle moving in an erroneous and unauthorized direction. When visual capture device 240 fails to recognize the presence of such vehicle, either due to weather and environmental conditions, such as fog or sun reflection, or inactivity, sensor 245 becomes necessary to recognize the offending vehicle. Sensor 245 can be a pulse radar, a continuous wave radar (Doppler Radar), or a combination of the both (Pulse-Doppler Radar). Pulse radars may accurately predict the distance of a target, but they require a number of pulses to evaluate the speed and direction of the target. Continuous wave radars can evaluate the speed and direction of the target but are unable to evaluate the distance from a target. Therefore, sensor 245 may be a Pulse-Doppler Radar that provides distance data as well as speed and direction data of a target. Further, sensor 245 may be a Mono-pulse Doppler Radar that functions as a pulse-doppler radar, but measures distance, speed, position, and direction of a target in only one pulse. In some implementations, a Mono-pulse Doppler Radar may be used to locate the traffic lane in which the offending vehicle is moving.

One or more detection devices 200 cover the total width of the road at all distances. Therefore, beam width of a beam deployed from sensor 245 covers the total width of the road at the maximum range of sensor 245 while any additional beams from sensor 245 cover the road at shorter distances and fade as the distance increases. The power of the beam and/or a range gate system can be used to cover the total width of the road for a reasonable distance.

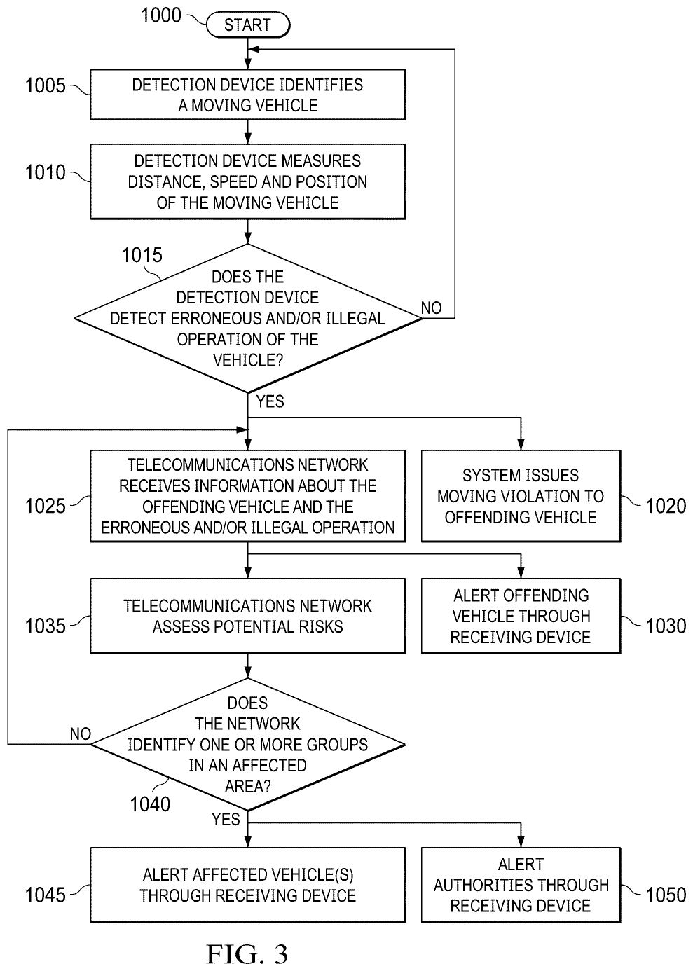

FIG. 3 provides a flow chart of an example method or process for using an example implementation of the disclosed vehicle warning system. In FIG. 3, the method starts at step 1000; a detection device identifies a moving vehicle at step 1005; the detection device measures the distance of the vehicle from the detection device, the speed of the vehicle, and the position of the vehicle at step 1010; the detection device then determines whether the vehicle is travelling in an erroneous and/or illegal direction at decision point 1015; if the detection device determines the vehicle is not travelling in an erroneous and/or illegal direction, the process returns to step 1000; if the detection device determines erroneous and/or illegal operation: (i) the system issues a moving violation to the offending vehicle at step 1020; and (ii) a telecommunications network receives information from the detection device about the offending vehicle and the erroneous and/or illegal operation at step 1025; the system alerts the offending vehicle of the erroneous and/or illegal operation through a receiving device at step 1030; the telecommunications network assesses the potential risks of such erroneous and/or illegal operation at step 1035; the telecommunications network assesses the potential risks of such erroneous and/or illegal operation at step 1035; the telecommunications network then determines whether there are one or more groups of potentially affected vehicles and/or vehicle operators based on proximity to an affected area at decision point 1040; if the network does not identify any potentially affected groups, the process continues at step 1025; if the network does identify one or more potentially affected groups: (i) the system alerts the one or more affected vehicles of the erroneous and/or illegal operation through a receiving device at step 1045; and (ii) the system alerts relevant authorities of the erroneous and/or illegal operation through a receiving device at step 1050.

A primary advantage of the disclosed system is that it identifies erroneous and/or illegal operation of vehicles and other types of transportation, and issues warnings and information to the offending vehicle, nearby affected vehicles, and the relevant authorities. Other advantages of the disclosed system include the following: (i) the system uses optical indicators/cameras and RF sensors and communication systems to more accurately locate vehicles than GPS locating; (ii) the system uses a Pulse Doppler Radar that is both a pulse radar providing distance and a continuous wave radar providing speed and direction; (iii) a Monopulse Doppler Radar may be used to measure speed, direction, and distance in only one pulse; (iv) the detection device communicates with the offending vehicle's computer system and/or radio to obtain registration plate numbers and VIN of the offending vehicle, thereby identifying the offending vehicle and its operator; and (v) moving violations can be issued to the offending vehicle's operator remotely, without physical issuance by an officer or other relevant authority.

A computer system in accordance with the present disclosure can be accessed via any suitable technique, such as a web-browser. In some embodiments, the systems and methods described herein can be a web-based application or a stand-alone executable. Additionally, in some embodiments, the systems and methods described herein can integrate with other systems of various types. Any suitable device can be used to access, or execute, one or more portions of the systems for warning a vehicle operator, such as laptop computers, desktop computers, smart phones, tablet computers, and the like.

Interaction with the detection system and/or the receiving device can be possible and may include, without limitation, keyboard entry, writing from pen, stylus, finger, or the like, with a computer mouse, or other forms of input (voice recognition, etc.). A user, e.g., vehicle operator or passenger, may receive real-time feedback, or at least near real-time feedback, or may synchronize with the detection system and/or the receiving device at a later date.

The description of embodiments and examples has been presented for purposes of illustration and description. It is not intended to be exhaustive or limiting to the forms described. Numerous modifications are possible in light of the teachings herein. Some of those modifications have been discussed, and others will be understood by those skilled in the art. The embodiments were chosen and described in order to illustrate principles of various embodiments as are suited to particular uses contemplated. The scope is, of course, not limited to the examples set forth herein, but can be employed in any number of applications and equivalent devices by those of ordinary skill in the art.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. A vehicle warning system, comprising:
(a) at least one detection device having instructions stored in a memory and executed by one or more processors communicatively coupled with a capture device and a sensor, wherein the one or more processors are configured to:
(i) receive identification data and detection data of a vehicle travelling along a path from the at least one detection device, wherein the detection data includes distance, speed, and position data measured by the sensor;
(ii) determine whether the vehicle is travelling along the path in an erroneous direction; and
(iii) provide a warning across a network to a receiving device associated with the vehicle, wherein the warning alerts an operator of the vehicle of travel in the erroneous direction.

2. The vehicle warning system of claim 1, wherein the one or more processors are further configured to, through the network:
(a) identify one or more groups of potentially affected vehicles based on proximity to the vehicle; and
(b) provide a second warning to a second receiving device associated with the one or more groups of potentially affected vehicles, wherein the second warning alerts a second operator of the one or more groups of potentially affected vehicles of the vehicle travelling in the erroneous direction.

3. The vehicle warning system of claim 2, wherein the one or more groups of potentially affected vehicles includes vehicles approaching the vehicle, vehicles being approached by the vehicle, traffic, emergency, law authorities, or combinations thereof.

4. The vehicle warning system of claim 1, wherein the one or more processors are further configured to remotely issue a moving violation to the vehicle if the vehicle is travelling along the path in the erroneous direction.

5. The vehicle warning system of claim 1, wherein the capture device comprises a camera operable to capture the identification data of the vehicle, wherein the identification data includes vehicle make, vehicle model, license plate numbers, or combinations thereof.

6. The vehicle warning system of claim 1, wherein the sensor is a Mono-Pulse Doppler Radar that measures the detection data in one pulse.

7. The vehicle warning system of claim 1, wherein the receiving device associated with the vehicle comprises:
(a) a display, wherein the warning is visually presented to the operator through the display; and
(b) a speaker, wherein the warning is audibly presented to the operator through the speaker.

8. The vehicle warning system of claim 1, wherein the warning is presented to the operator through the receiving device in the form of a vibration, wherein the vibration is emitted through a steering wheel, seat, or combinations thereof.

9. The vehicle warning system of claim 1, wherein the vehicle travelling along the path includes automobiles, trains, trams, motorcycles, or bicycles.

10. A vehicle warning method, comprising:
(a) positioning at least one detection device comprising a capture device and a sensor along a path of travel;
(b) receiving, by one or more processors communicatively coupled with the capture device and the sensor, identification data and detection data of a vehicle travelling along the path of travel, wherein the detection data includes distance, speed, and position data measured by the sensor;
(c) determining, by the one or more processors, whether the vehicle is travelling along the path in an erroneous direction; and
(d) providing, by the one or more processors, a warning across a network to a receiving device associated with the vehicle, wherein the warning alerts an operator of the vehicle of travel in the erroneous direction.

11. The vehicle warning method of claim 10, further comprising, by the one or more processors:
(a) identifying one or more groups of potentially affected vehicles based on proximity to the vehicle; and
(b) providing a second warning to a second receiving device associated with the one or more groups of potentially affected vehicles, wherein the second warning alerts a second operator of the one or more groups of potentially affected vehicles of the vehicle travelling in the erroneous direction.

12. The vehicle warning method of claim 11, wherein the one or more groups of potentially affected vehicles includes vehicles approaching the vehicle, vehicles being approached by the vehicle, traffic, emergency, and law authorities, or combinations thereof.

13. The vehicle warning method of claim 10, further comprising, by the one or more processors, remotely issuing a moving violation to the vehicle if the vehicle is travelling along the path in the erroneous direction.

14. The vehicle warning method of claim 10, wherein the capture device comprises a camera operable to capture the identification data of the vehicle, wherein the identification data includes vehicle make, vehicle model, license plate numbers, or combinations thereof.

15. The vehicle warning method of claim 10, wherein the sensor is a Mono-Pulse Doppler Radar that measures the detection data in one pulse.

16. The vehicle warning method of claim 10, wherein the receiving device associated with the vehicle comprises:
(a) a display, wherein the warning is visually presented to the operator through the display; and
(b) a speaker, wherein the warning is audibly presented to the operator through the speaker.

17. The vehicle warning method of claim 10, wherein the warning is presented to the operator through the receiving device in the form of a vibration, wherein the vibration is emitted through a steering wheel, seat, or combinations thereof.

18. The vehicle warning system of claim 10, wherein the vehicle travelling along the path includes automobiles, trains, trams, motorcycles, or bicycles.

19. A warning system for detecting a vehicle travelling in an erroneous direction along a path of travel, comprising:
(a) at least one detection device having instructions stored in a memory and executed by one or more processors communicatively coupled with a capture device and a Mono-Pulse Doppler Radar, wherein the one or more processors are configured to:
(i) receive identification data and detection data of the vehicle from the at least one detection device, wherein the detection data includes distance, speed, and position data measured by the Mono-Pulse Doppler Radar;
(ii) determine whether the vehicle is travelling along the path in an erroneous direction;
(iii) provide a warning across a network to a receiving device associated with the vehicle, wherein the warning alerts an operator of the vehicle of travel in the erroneous direction;
(iv) through the network, identify one or more potentially affected vehicles along the path of travel based on proximity to the vehicle;
(v) through the network, provide a second warning to a second receiving device associated with the one or more potentially affected vehicles, wherein the second warning alerts a second operator of the one or more potentially affected vehicles of the vehicle travelling in the erroneous direction; and
(vi) through the network, provide a third warning to a third receiving device associated with one or more traffic, emergency, or law authorities, wherein the third warning alerts the authorities of the vehicle travelling in the erroneous direction.

20. The vehicle warning system of claim 19, wherein the one or more processors are further configured to remotely issue a moving violation to the vehicle if the vehicle is travelling along the path in the erroneous direction.
